(19) United States
(12) Patent Application Publication
(10) Pub. No.: US 2019/0111559 A1
(43) Pub. Date: Apr. 18, 2019

(54) Device for Removing and Reintroducing Parking Tickets and Parking Vouchers From and into the Automatic Machines Provided for Them

(71) Applicant: Heinz Beck Kunststoffverarbeitung GmbH, Tiefenbach (DE)

(72) Inventor: Heinz BECK, Tiefenbach (DE)

(21) Appl. No.: 16/082,654

(22) PCT Filed: Mar. 14, 2017
(86) PCT No.: PCT/DE2017/100205

§ 371 Date: Sep. 6, 2018

(30) Foreign Application Priority Data
Mar. 18, 2016 (DE) 10 2016 003 348.7
Sep. 2, 2016 (DE) 10 2016 010 927.0

(51) Int. Cl. B25J 1/04; G07F 17/42; B25B 5/04; B25B 5/06; B25B 9/02

(52) U.S. Cl. CPC B25J 1/04; G07F 17/42; G06Q 2240/00; B25B 5/06; B25B 9/02; B25B 5/04

(57) ABSTRACT

A device configured to remove and reintroduce parking tickets from and into a related automatic machine includes an elongated member having a head part, which receives the parking ticket and has an end portion adapted to be used as a pusher element for actuating a request pushbutton key on the automatic machine. A insertion slot with clamping elements or securing elements is formed in the head part, the securing elements being each configured so that, when they receive the parking ticket, and the parking ticket is returned from an issuing slot in the automatic machine into the insertion slot, they automatically exert different securing forces.

The invention relates to a device which makes it easier to remove and reintroduce parking cards and parking vouchers from and into the automatic machines provided therefore from inside a motor vehicle.

In covered car parks and open-air car parks that are equipped with a barrier and an automatic machine that operates such barriers, the problem occurs very frequently that when driving into and out of the facility the distance between the vehicle and the automatic machine is too great to be able to reach the automatic machine by stretching the arm through the open vehicle window. The vehicle driver is therefore compelled either to adjust the position of the vehicle and drive closer to the automatic machine or to open the vehicle door and get out to operate the automatic machine. Both situations often present difficulties and also cause annoyance to drivers of vehicles behind the first vehicle, since their waiting time is prolonged thereby.

It therefore seems practical to suggest a means to assist with this situation, with which the arm may be “extended” in a certain manner, so that the automatic machine can be operated from the vehicle without undue physical contortion.

It should be designed in such manner that it may be used to press the request key for output of the parking card, which key is usually arranged flush with the front plate of the automatic machine or recessed therein.

In any case, it should also be ensured that the means may also be used for removing parking cards and parking vouchers of various material thicknesses from the automatic machine and for introducing them into it again. Otherwise, if the parking cards and parking vouchers are thin, there is a danger that they may be squashed, or that they are not grasped at all by the gripping device when an attempt is made to remove them from the output slot. In the case of very thick cards, it may happen that they cannot be introduced into the slot in the means.

A device of such kind should also be designed such that it is made possible to push the gripping device onto a parking card made available in the output slot of the automatic machine easily and accurately even with the arm fully outstretched.

Thus, for the reasons stated previously the resistance should be as low as possible when retrieving from the output tray of the automatic machine and when introducing an item into the slot of the assistance device.

Above all, however, the device should be designed such that when the parking card issued is retrieved from the output slot of the automatic machine by the holding device of the assistance means, a sufficiently strong retaining force is exerted on the parking card to ensure that it can be grasped and pulled out reliably even if it is retained with a stronger force by the output mechanism of the automatic machine.

In the same way, when the parking card is reintroduced before driving out the retaining force with which the parking card is held by the assistance device should not be too strong, since otherwise the card cannot be grasped by the pull-in mechanism of the automatic machine and/or will not be pulled in.

No less importantly, the assistance device should be usable with all existing automatic machines.

Thus, the requirements profile for the design of the head part of such an assistance device may be summarised as follows:

The head part should be designed in such manner that the request key on the automatic machine can be pressed without difficulty.

The holding device should be able to accept parking cards and parking vouchers of various material thicknesses.

The holding device should be designed such that it is possible to generate retaining forces of at least two different strengths therewith as necessary for fixing the parking card in the interior of the head part:

a) A strong retaining force enabling the parking card to be pulled out of the output slot of the automatic machine reliably with the aid of the device.

b) A weak resistance force when introducing the parking card both into the slot of the automatic machine and into the slot in the device.

c) A weak retaining force enabling the parking card to be pulled out of the slot of the device by the pull-in mechanism of the automatic machine.

Gripping means for grasping parking vouchers so that they can be introduced into an automatic machine or removed therefrom while seated in the vehicle belong to the related art. An example of such is described in DE 20 2014 006 969 U1, and is constructed in the manner of a stork bill with two lever arms of equal length that are connected to each other by an articulation in the middle thereof, and one end of which has a tongs-like head part for grasping a parking card or parking voucher. Actuation for opening and closing the tongs-like head part is carried out a the other end of the two lever arms and can only by performed with one hand after much practice.

A simplification in this respect is offered by the similarly constructed scissor-like gripping means of DE 20 2013 004 097 U1, whose longer, telescopic lever arms have grip openings at the end thereof, but which are positioned so far apart when the lever arms are fully extended that it is difficult to hold them with the fingers of one hand.

A gripper arm with a housing in which an angle lever is mounted rotatably close to the open end of the arm is known from JP 10198833 A. It has one short lever arm and one long lever arm in which functions as a grasping leg, which is pressed against a fixed position gripping arm to hold a parking voucher by a spring which acts on the short lever arm. A trigger arrangement connected to the short lever arm via a cord serves to release the parking voucher.

Finally, DE 195 11 345 A1 describes a parking voucher gripper with a gripping element embodied as a retaining spring, which must be displaced axially by means of a slider in a hollow arm so that the resilient end thereof can be pressed against the gripping end of the hollow arm.

It is therefore the object of the present invention to describe a device with which the request key of the automatic machine can be operated easily and parking cards of different material thicknesses can also be removed from and reintroduced into automatic machined.

This object is solve according to the invention with the features described in claim 1.

The subordinate claims define advantageous refinements of the invention.

Although the following description refers only to parking cards for the sake of simplicity, it is to be understood to refer to parking vouchers as well.

In order to solve this object, it is provided that the assistance device is of relatively narrow, compact design, so that it may also be used to press request keys of small diameter. Advantageously, it also includes an element forming a protrusion or a pusher element on the frontal face of the head part. This pusher element may be constructed or arranged either above or below the slot in the head part. Thus, this pusher element may advantageously be constructed as a protrusion of the head part, but an additional pusher element, a bolt for example, may be attached to the head part of the device.

If the circumference of the frontal face of the device is smaller than the surface of the request key on the automatic machine, the request key may also be pressed using the entire frontal face.

If the frontal face of the device is embodied as a pusher element in the form of a projection, the free end of the pusher element protrudes only slightly beyond the frontal face of the head part, since the actuation path of a request key is only a few millimetres long anyway. This pusher element is advantageously arranged or conformed so as to be inclined upwards or downwards, so that a funnel-like insertion aid for the parking card is created thereby in conjunction with a correspondingly shaped frontal face of the opposite area of the head part. This makes it much easier to push it precisely onto a parking card which is issued in the output slot of the automatic machine.

The slot arranged in the head part of the device is designed so that up to about a third or at maximum a half of a parking card which is introduced is taken up. The slot itself has a clearance height of about 2 to 3 mm, thereby ensuring in all cases that parking cards with greater material thickness can also be introduced without difficulty.

At least one flexible or movable holding element, e.g., a leaf spring is arranged in the interior of the head part to hold the introduced parking card in place.

In this way, the special design of the holding device makes it possible for the parking card to slide into the slot of the head part without excessive resistance during the removal operation from the automatic machine. Moreover, only a small clamping force is exerted on the parking card when the parking card is reintroduced into the automatic machine before driving out.

This is achieved because the holding element yields upon contact with the introduced parking card. The holding element is only able to exert enough contact pressure on the introduced part of the parking card to ensure that it is held firmly against the opposited side of the slot and is thus held therein.

With the holding device according to the invention it is thus ensured in all cases that parking cards of different material thicknesses are fixed in the head part slot almost identical retaining force.

When the parking card is pulled out of the head part slot, the contact pressure acting on the parking card increases automatically. This is achieved by the arrangement of holding elements which have the property of yielding in a direction towards the handle of the device whereas they manifest a friction-increasing effect when moving backwards.

Finally, a stronger retaining force is needed when a parking card issued in the output slot of the automatic machine after it has been requested is to be removed by means of the device.

Thus, in a preferred embodiment a clamping bar is arranged in the head part of the device in such manner that a parking card that has been introduced into the slot of the head part is held or released depending on the position of the head part. For this purpose, the device is simply rotated through 180°. In this context—in a position in which the clamping bar arrangement is located above the slot in the head part—the introduced parking card is held in place by the clamping bar, wherein an attachment arranged in the lower front area presses against the upper side of the parking card. The retaining force is strengthened automatically due to the pulling motion by the eccentric mounting of the clamping bar, and is consequently also strong enough to enable reliable removal of a parking card provided for removal in the output slot of the automatic machine, which however is held in place by a relatively strong retaining force.

The retaining force of the device may be increased further by the use of suitable materials for the clamping bar or its surface.

In a further, also advantageous embodiment, the lower part of the introduction area on the the head part is furnished with a friction surface. An applied rubber or foam rubber coating is advantageously suitable for this. However, another friction increasing material, for example a strip of sandpaper, may be arranged. It is also conceivable to structure the surface of the introduction area of the base part with a roughened contour or provide it with grooves.

And equally importantly, due to the increased retaining force when the parking card is pulled out of the output slot of the automatic machine it is quite sufficient if only a corner of the parking card is grasped by the head part to enable it to be removed reliably from the output slot of the automatic machine.

In summary, from the preceding description it may be concluded that the device according to the invention has a total of at least two retaining force strengths, each of of which may be used according to requirements:

A weak resistance and retaining force which is exerted when the head part is pushed onto the parking card issued in the output slot of the automatic machine, when the parking card is inserted in the head part and when the card is reintroduced into the automatic machine when exiting the parking facility,

A considerably increased retaining force which is exerted when the parking card is pulled out of the output slot of the automatic machine.

In the following text, the invention will be explained in greater detail on the basis of embodiments and with reference to the drawing.

In the drawing:

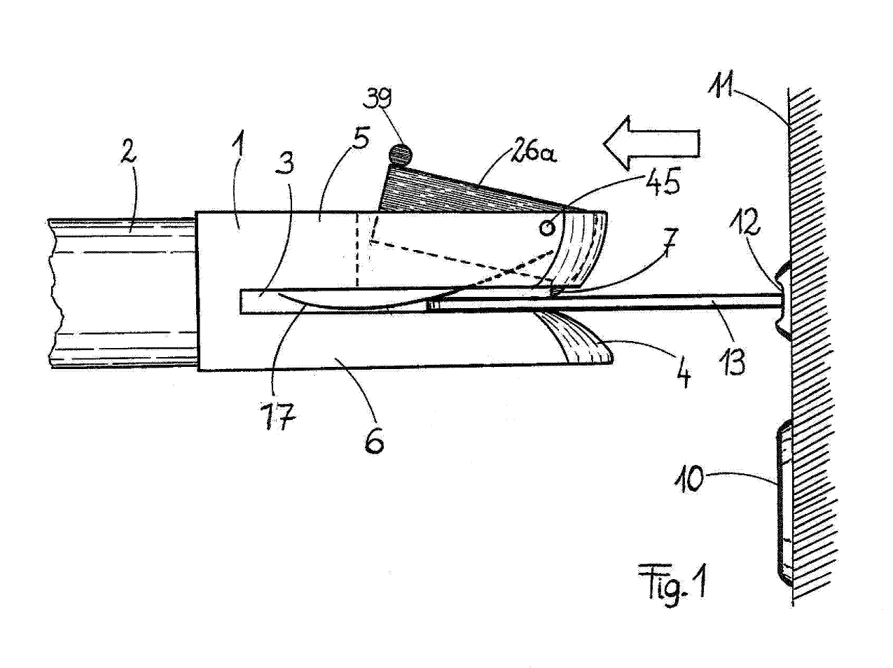

FIG. 1 shows a side view of the head part of a device with a parking card introduced into the slot thereof as the parking card is pulled out of the output slot of an automatic machine,

FIG. 2 shows the head part as it is brought towards the parking card issued in the output slot of the automatic machine for removal,

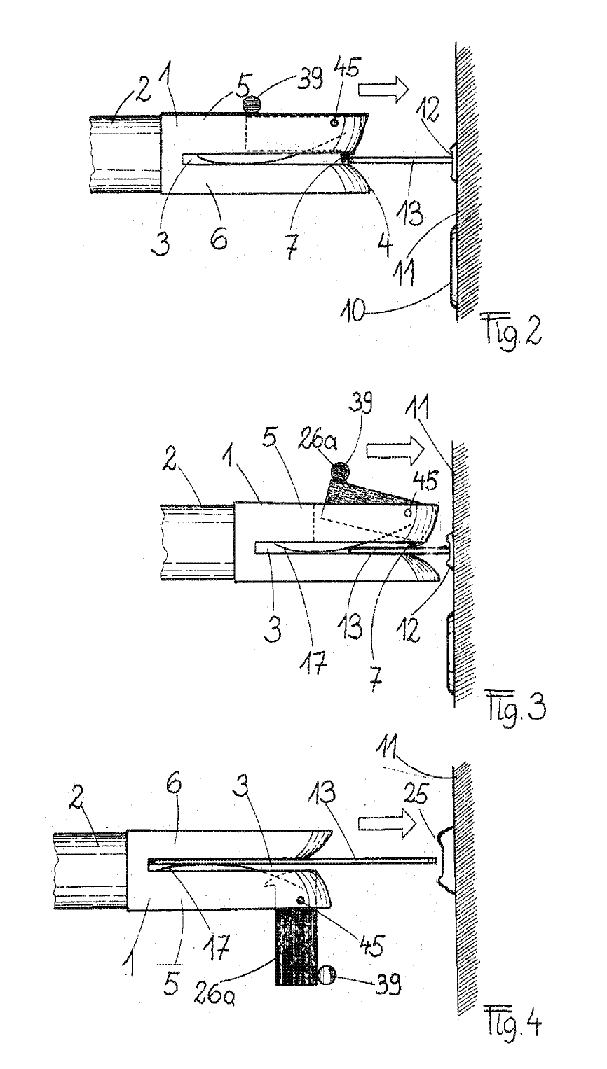

FIG. 3 shows the head part as it is being pushed onto the issued parking card,

FIG. 4 shows the head part after a rotation through 180° when the parking card is reintroduced into the input slot of the automatic machine,

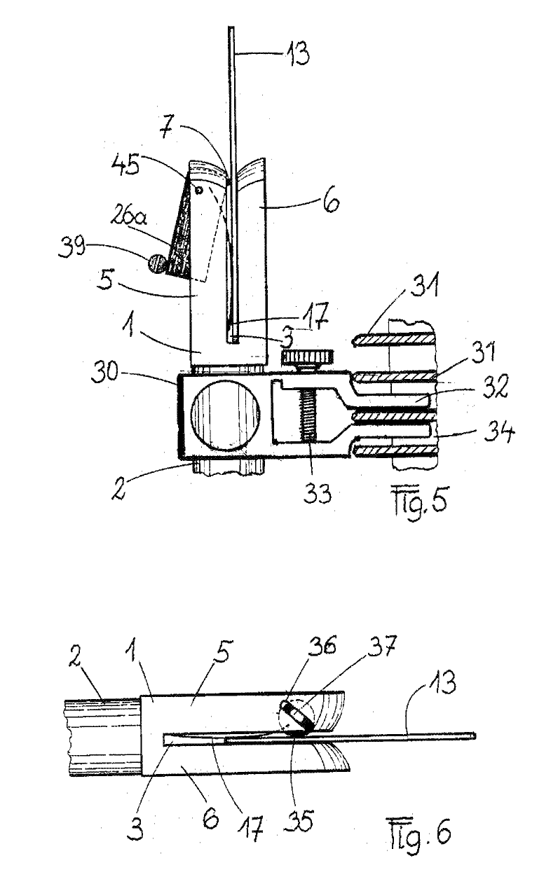

FIG. 5 shows a partially cutaway side view of the device with a parking card introduced into the head part thereof, wherein the device is mounted in a bracket attached to a ventilation register vane of a motor car,

FIG. 6 shows a variant of the head part with a parking card introduced into the slot,

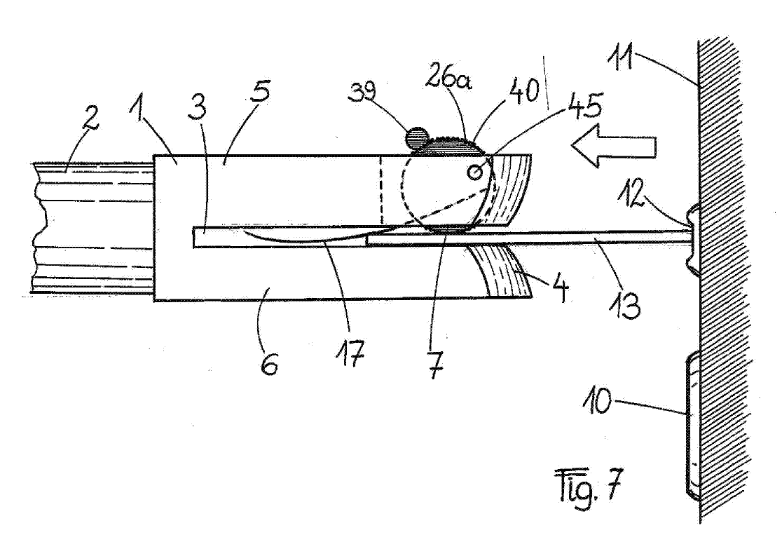

FIG. 7 shows a side view of a variant of a head part,

FIG. 8 shows a partially cutaway side view of a further variant of the head part,

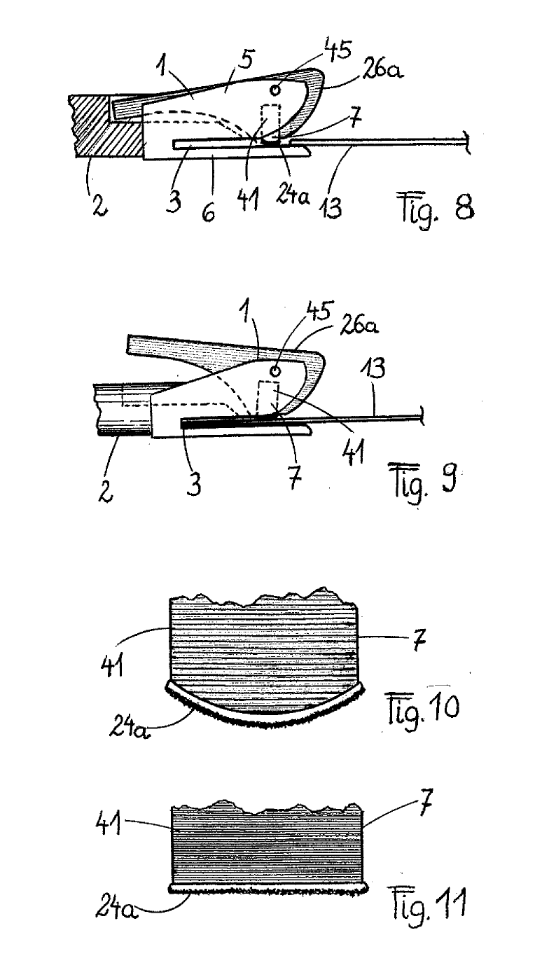

FIG. 9 shows the variant of FIG. 8 with the clamping bar in another position,

FIG. 10 shows an enlarged detail view of the holding element arranged in the clamping bar,

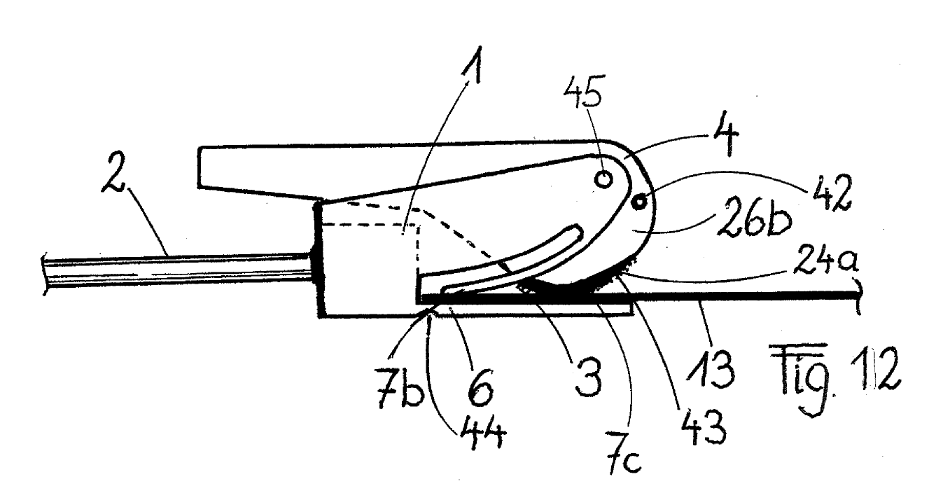

FIG. 11 shows a variant of FIG. 10,

FIG. 12 shows side view of a further variant of the head part with dashed representation of hidden parts and with a clamping bar which has received surface treatment,

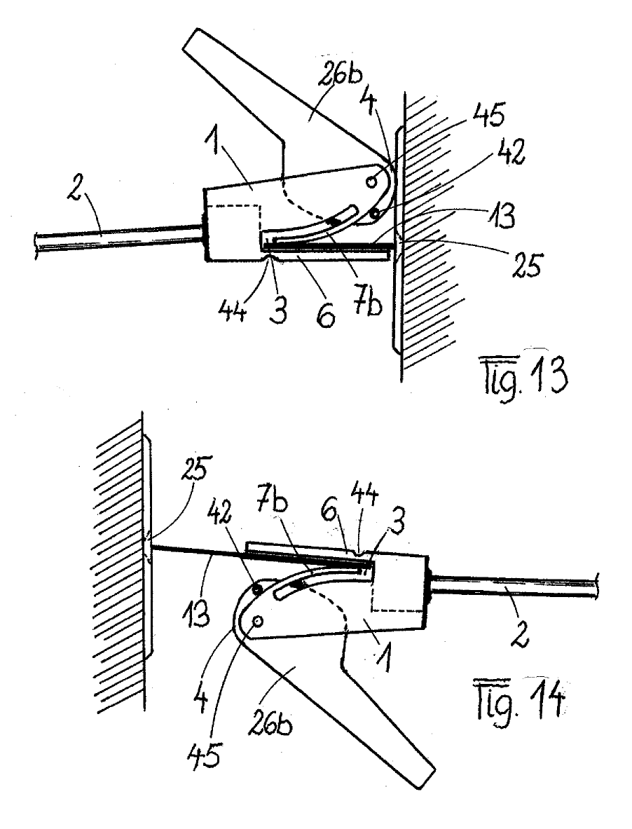

FIG. 13 shows the variant of FIG. 12 at the moment a parking card is introduced into the input slot of an automatic machine, and

FIG. 14 shows the variant of FIG. 13 during the same operation operation but with an alternative use of the device.

The device according to the invention has a substantially cuboid head part 1 (see FIG. 1), which is attached to a telescopic grip bar 2 and has a slot 3 in its middle part for taking up a parking card 13. The clearance height of the slot 3 is about 2 mm an so about twice as large as the material thickness of a typical parking card 13.

In FIG. 1, the device is shown at the moment the parking card 13 issued by an automatic machine 11 is pulled out of the output slot 12. The parking card 13 having been introduced into the slot 3 of the head part 1 is clamped firmly by a leaf spring 17 which is anchored in the cover plate 5 of the head part 1.

The parking card 13 is held securely inside the slot 3 by a two-armed clamping bar 26a arranged inside the cover plate 5. The clamping bar is arranged in a recess provided in the cover plate 5 so as to be rotatable about a cam axis 45 in such manner that a part of its longer lever arm protrudes above the upper side of the cover plate 5 as soon as a parking card 13 has been introduced into the slot 3. In this case, a holding element 7 of the clamping bar 26a, which is arranged at the bottom and in the front of the clamping bar and is embodied as an attachment or lug, impinges on the upper side of the parking card 13.

When the parking card 13 is pulled out of the automatic machine it is held in place by means of the clamping bar 26a with holding element 7, wherein the underside thereof is pressed against the underside of the slot 3. Here, the holding element 7 of the clamping bar 26a is designed as a pin or wedge. However, it may also have a rounded shape or be constructed in the shape of a half cylinder.

The holding element 7 may also be a part which has been inserted in the clamping bar 26a. It advantageously consists of a material that increases frictional resistance, e.g., rubber with emery cloth.

In the example shown, the parking card 13 is only introduced a short distance into the slot 3 in the head part 1. However, it is also possible to push the head part 1 farther onto an issued parking card 13 in the output slot 12 of the automatic machine 11, wherein it may then also impinged upon by the leaf spring 17 that protrudes into the slot 3.

Due to the special shape of the clamping bar 26a, it is possible to hold parking cards 13 having various thicknesses from 0.2 mm up to 1.0 mm firmly in place.

The frontal face of the head part 1 is rounded and at the same time shaped in such manner that a funnel-like introduction opening is formed, which in turn makes it easier to push the head part 1 accurately onto an issued parking card 13 in the output slot 12. In this process, the front edge of the base part 6 of the head part 1 extends beyond the front edge of the cover plate 5 by a few millimetres and so serves as a pusher element 4, with which the request key 10 of the automatic machine 11 may be operated.

Another knob 39 is arranged in the rear upper area, and this serves to make it easier to lift the clamping bar 26a by hand.

In the representation of FIG. 2 it is shown how after the request key 10 is operated an issued parking card 13 in the output slot 12 of the automatic machine 11 is taken up by the head part 1 of the device. The head part 1 is brought towards the frontal face of the parking card 13, and the card is introduced into the slot 3 by virtue of the funnel-like introduction opening. The frontal face of the parking card 13 then bears on the holding element 7.

FIG. 3 shows how the attachment operation continues subsequently. If the head part 1 is moved still closer to the automatic machine 11, the parking card 13 introduced into the slot 3 causes the holding element 7 to be pressed backwards towards the grip bar 2. At the same time, the rear, longer lever arm of the clamping bar 26a is tilted upwards about the eccentric swivel axis 45. When the parking card 13 is subsequently pulled out of the automatic machine 11, the clamping bar 26a with its holding element 7 fixes the parking card 13 securely in the head part 1 by friction. This retaining force is not created until the parking card 13 is pulled out of the automatic machine 11. The parking card 13 which is firmly held in this way may then be pulled of the output slot 12 of the automatic machine 11 without difficulty in the manner described in FIG. 1.

FIG. 4 shows how the reverse operation takes place, that is to say the reintroduction of the parking card 13 into an input slot 25 of the automatic machine 11. For this, the device is rotated through 180° about the longitudinal axis of the grip bar 2, so that the cover plate 5 now faces downwards and the base part 6 is uppermost. The effect of this is that the parking card 13 introduced into the slot 3 is no longer constrained by the force of clamping bar 26a with holding element 7, since this is now hangs downwards. The part of the parking card 13 that has been inserted in the slot 3 is thus only exposed to the force from the leaf spring 17. The holding pressure exerted thereby is sufficient for moving the parking card 13 reliably towards the automatic machine 11 and to push it into the assigned input slot 25. The low holding pressure also ensures that the inserted parking card 13 can be grasped and also drawn in easily by the pull-in mechanism of the automatic machine 11.

FIG. 5 shows how the device according to the invention can be stored in the vehicle interior. For this purpose, a special bracket 30 is provided which is mounted on a ventilation register vane 31 provided on the dashboard. The bracket 30 is fastened to one of the ventilation register vanes 31 by means of a clip 32, with can be opened or closed with a knurled screw 33. The grip bar 2 of the device is pushed into a seating in the bracket 30.

A parking card 13 is inserted in the slot 3 of the head part 1 and is impinged upon by the attachment 38 mounted on the clamping bar 26a and by the leaf spring 17. The device thus also fulfils the function of a holder for storing the parking card 13. In order to remove the parking card 13 from the head part, the clamping bar 26a is raised via the knob 39 located in the upper rear area, which causes the holding element 7 to swivel away from the parking card 13.

In the variant according to FIG. 6, a rubber cylinder 35 is provided as holding element 7 instead of the clamping bar 26a. An elongated guide element 37 is located on each of the frontal faces of this cylinder. These guide elements 37 are each arranged so that they are displaceable in an assigned guide slot 36. This guide slot 36 is aligned with an upward slope, so that when the parking card 13 is introduced into the slot 3 of the head part 1, the rubber cylinder 35 recoils in this direction and is pushed obliquely upwards. Consequently, the parking card 13 may be slid into the slot 3 relatively easily, whereas when the parking card 13 is pulled out of the slot 3 the rubber cylinder 35 forms a wedge with the parking card 13, so that greater retaining forces are generated.

FIG. 7 shows a further advantageous design of the device according to the invention. This is substantially configured similarly to the device shown in FIGS. 1 to 5. In this case, the clamping bar 26a consists of a roller cam 40 with eccentric axis 45. Its circumferential side is furnished with grooves to increase friction. The representation shows the operation of removing the parking card 13 from the output slot 12 of the automatic machine 11. In this context, the free end of the parking card 13 is advanced into the slot 3 of head part 1 until its frontal face abuts with the leaf spring 17. The upper side of the parking card 13 is impinged upon by the clamping bar 26a, which is rotatable about the cam axis 45.

By virtue of the fact that the roller cam 40 forms a wedge with the upper side of the parking card 13 during the pulling motion, the contact pressure is increased to such an extent that the firm friction lock is assured, and the head part 1 is prevented from slipping off the parking card 13.

In the variant according to FIG. 8, the holding element 7 arranged in the clamping bar 26a is furnished with a friction surface 24a in the area of the bearing surface and is constructed as an eccentrically mounted clamping bar 26a with swivel axis 45, and having a clamping insert 41 arranged in the lower part thereof. The device is in a position in which a parking card 13 can be introduced into the slot 3. The rear, longer lever arm of the clamping bar 26a is swivelled downwards, wherein the free end of the clamping insert 41 furnished with a friction surface 24a rests on the upper side of the base part 6.

FIG. 9 shows the position of the clamping bar 26a after a parking card 13 has been introduced into the slot 3 of the head part 1. In this case, the rear, longer lever arm thereof slopes upwards. The effect of the eccentric arrangement is that the holding element 7 is pressed firmly against the surface of the parking card 13, creating a secure friction lock. Since in this example the parking card 13 only has a small material thickness and is relatively thin, the clamping insert 41 is only swivelled backwards slightly. If a thicker parking card 13 were introduced, it would swivel backwards further, and the rear, free lever arm of the clamping bar 26a would be pivoted upwards correspondingly further.

FIG. 10 shows an enlarged detail of the lower part of the clamping insert 41, which in this case is rounded and has a friction surface 24a. Said surface may consist for example of a glued piece of sandpaper, but it can also have a different form provided it can guarantee optimal clamping effect. For example, the clamping insert 41 which is preferably made of rubber may be roughened or coated to a corresponding degree.

In the variant according to FIG. 11, the clamping insert 41 embodied as holding element 7 is designed with a straight underside and again has a friction surface 24a.

The design of the embodiment according to FIG. 12 is very simple and at the same time highly practical. The drawing shows how a parking card 13 introduced into the device is fixed in the head part 1. Similarly to the previous devices, the clamping bar 26b is mounted so as to be rotatable about the eccentric axis 45 in the head part 1, wherein the lower front part thereof bears on the inserted parking card 13 and presses it downwards against the base part 6. In this embodiment as well, the free end of the parking card 13, which is introduced into the slot 3 of the device, is fixed additionally with a flexible element arranged in the head part 1. Said flexible element consists of elastic holding elements 7b which are arranged on both sides of the clamping bar 26b. For this purpose, the two sidewalls which fix the clamping bar 26b have a longitudinal slot that slopes downwards and to the rear. In this way, two thin ribs are formed, the free ends of which bear on the upper side of the base part 6 and thus form a springy element.

The frontal face of the clamping bar 26b is rounded and has a stopper 42 in the front area which limits the swivel radius. The front edge of the clamping bar 26b protrudes slightly beyond the base part 6 and thus also severs as a pusher element 4 for operating the request key 10 of the automatic machine.

The lower are of the clamping bar 26b, which is assigned to the base part 6, has a friction surface 24a which fixes the introduced parking card 13. To this end, a friction lining 43 is applied to the area concerned.

There is a material attenuation 44 in the rear part of the base part 6, i.e. roughly level with the end of the slot. This makes it easier for even thick parking cards 13 to be released by the head part 1 during the process of introducing the card into the automatic car park machines because the base part 6 is able to fold downwards a little when the parking card 13 is pulled.

FIG. 13 illustrates the operation of introducing the parking card 13 into the input slot 25 of the automatic machine 11. In this case, the parking card 13 has already been introduced, wherein it has already been drawn in almost completely by the pull-in mechanism. The drawing shows clearly that at this moment the front edge of the clamping bar 26b comes to bear on the cover plate of the input slot 25, and the rear part of the clamping bar 26b is swivelled upwards. As a result, the part that impinges on the parking card 13 is also swivelled upwards. The swivel path is limited by the stopper 42. Consequently, the parking card 13 is only fixed by the two holding elements 7b arranged on either side of the clamping bar 26b and can be drawn into the interior of the automatic machine by said machine's pull-in mechanism.

FIG. 14 illustrates that an operation for introducing the parking card 13 into the input slot of an automatic machine in the manner described previously is possible in this variant of the device too. In this case, the device is rotated through 180°, so that the longer lever arm of the clamping bar 26b hangs down under the force of gravity. Once again, the swivel path is limited by the stopper 42, which bears on the lower front part of the head part 1. Accordingly, the parking card 13 is no longer exposed to the force exerted by the clamping bar 26b, but is only fixed by the holding element 7b. The parking card 13, which already protrudes slightly into the input slot 25 of the automatic machine, may thus be grasped by the pull-in mechanism and pulled out of the head part 1 of the device again without difficulty.

The device according to the invention functions as follows:

In order to request a parking card 13, the device which consists of a head part 1 with grip bar 2 is moved towards the request key 10 of the automatic machine 11. Then, the request key 10 is pressed with the pusher element 4 which is arranged on the frontal face of the head part 1.

The parking card 13 which is then issued in the output slot 12 of the automatic machine 11 can now be removed with the help of the device. To do this, the device is moved towards the free end of the parking card 13, which protrudes beyond the output slot 12 of the automatic machine 11. The operation of pushing the head part 1 onto the parking card 13 is made easier in that the front part of the head part 1, which is in the shape of a funnel-like insertion aid, only has to be brought into contact with the parking card 13 in order for the device to then be pushed a little further forwards. The free end of the parking card 13 is introduced into the slot 3 of the head part 1 without difficulty, since its height is sufficient to enable it to pick up even thicker parking cards 13. In the case of thin parking cards 13 as well, the danger that such cards may be squashed during the insertion process may be almost completely eliminated. The holding elements 7; 7a arranged in the slot 3 of the head part 1 are designed such that they recoil when pushed onto the issued parking card 13. This makes it possible for parking cards 13 of different thicknesses to be introduced with no significant resistance. However, the retaining force acting on a parking card that is introduced into the slot 3 is sufficient to be able to fix the parking card 13 securely in the slot 3.

The holding elements 7; 7a are designed such that parking cards 13 of various material thicknesses are held firmly in the slot 3 with almost exactly the same retaining force.

In the case of the embodiments with the clamping bar 26a arranged in the cover plate 5—according to FIGS. 1 to 5 and FIGS. 8 to 14—or the rubber cylinder 35, which is arranged in an upwardly sloping guide slot 36 (see FIG. 6) and the roller cam 40, depending on the use of the device as an aid for removing or reintroducing the parking card 13, rotation of the device through 180° is provided. If the parking card 13 is fixed in the removal position by the clamping bar 26a and the rubber cylinder 35 as well as by the impinging leaf spring 17, reliable removal from the output slot 12 is guaranteed. In this case, the respective clamping bar 26a automatically forms a wedge when the parking card 13 is pulled, wherein the parking card 13 is subjected to a pressure such that it can be pulled out of the output slot 12 of the automatic machine 11 without difficulty, even if strong retaining forces are exerted on it by the output mechanism.

In the preferred embodiment according to FIG. 12 and FIG. 13, the device does not need to be rotated through 180°. In this case, not only does the frontal face of the clamping bar 26b serve as a pusher element 4 for actuating the request key 10 of the automatic machine 11, but the particular design thereof also makes it possible to bring it into contact with the cover plate of the input slot 25 during the operation of introducing the parking card 13 into the input slot of the automatic machine 11, which causes the clamping bar 26b to swivelled upwards, wherein the swivel path is limited by the stopper 42. This cancels the exertion of force on the parking card 13 by the clamping bar 26b.

If the parking card in the is only exposed to the force exerted by the leaf spring 17 or the resilient holding elements 7b, the retaining pressure within the slot 3 is small enough to enable the parking card 13 to be reintroduced into the automatic machine 11 without difficulty.

Even if the pull-in roller of the automatic car park machine is already worn or heavily abraded, this condition should still not present any problems when grasping and pulling the parking card 13 into the input slot 25.

In the case of the devices according to FIGS. 1 to 6 and FIGS. 8 to 11, the movably arranged fixing element embodied as a clamping bar 26a or roller cam 40 (FIG. 7) is disposed such that in the raised position it impinges on the parking card 13 that is introduced into the slot 3. The contact pressure which is consequently exerted on the parking card 13 is increased when the parking card 13 is pulled out of the output slot 12 of the automatic machine 11 in that the part of the fixing element that exerts the pressure forms a wedge with the parking card 13. Thus it is ensured in all cases that the parking card 13 can be removed reliably from the automatic machine 11 even against a stronger retaining force.

The essential advantage of the devices according to the invention thus consists in that all design type of parking cards 13, from very thin to very thick cards, can be removed reliably from the output slot 12 of the automatic machine 11, since the pressure exerted on the parking card 13 by the respective fixing element is increased when the card is pulled.

After the card has been removed, the device is retracted into the interior of the vehicle with the parking card 13 held securely in the slot 3. In this context, there is a risk particularly in the open air that the parking card 13 might be torn out of the slot 3 in the head part 1 by windy or stormy weather. For this reason, the retaining mechanism arranged in the head part 1 is designed in some embodiments such that the retaining force of the holding elements 7 increases automatically in the event of a pulling motion acting on the parking card 13.

Upon driving out of the car park building or open-air car park, the parking card 13 is inserted in the slot 3 of the head part 1 manually and then introduced into the input slot 25 of the automatic machine 11 with the aid of the device. However, the retaining force is only strong enough to ensure that when the parking card 13 has been introduced into the input slot 25 of the automatic machine 11 it can be grasped and drawn in by the pull-in mechanism. If the resistance were too great or if the retaining force of the holding device in the head part 1 were too strong, the parking card 13 having been inserted would otherwise be ejected again.

Thus for example with the devices according to FIG. 4 or 14 the head part 1 may be rotated through 180°, wherein the clamping bar 26a; 26b or the roller cam 40 (FIG. 7) is automatically brought into a position in which no forces impinge on the parking card 13. In this case the parking card 13 is fixed solely by the leaf spring 17 which embodied as a holding element.

In the case of the device according to FIGS. 12 to 14, two procedures are possible for reintroducing the validated parking card 13 into the automatic machine:

Accordingly, it is possible after inserting the parking card 13 in the slot 3 of the head part 1 to guide the parking card 13 into the input slot 25 of the automatic machine in such manner that the clamping bar 26b is uppermost. At the moment in which the parking card 13 is gripped by the pull-in mechanism of the automatic machine, the head part 1 of the device is also pulled towards the machine automatically so that it comes to bear on the automatic machine. Because of the special shape of the frontal face of the clamping bar 26b, the bar is tilted upwards, causing the parking card 13 to be released so that it can be pulled into the machine completely.

In the alternative method (FIG. 4), the parking card 13 is inserted with the head part 1 rotated through 180°. In this position, the clamping bar 26b is on the underside of the head part 1, wherein the lever arm usually hangs down. However, if this becomes stuck, the pull-in operation is still not obstructed since—as explained previously—the lever arm of the clamping bar 26b folds down upon contact with the input slot 25 of the automatic machine, thereby releasing the parking card 13.

The device is advantageously designed in such manner that it is not damaged or destroyed even when very thick parking cards 13 are used of if it is used incorrectly. For this purpose, the retaining mechanism is of elastic construction, which in the device according to FIGS. 12 to 14 is achieved for example by a material attenuation 44 located on the base part 6.

In order to ensure that the device is always ready to hand in the vehicle, it is inserted in a bracket 30 mounted on the ventilation grille 39 (FIG. 5). In this context, the grip bar 2 engages in the assigned clip 32. The bracket 30 may then advantageously be swivelled in a desired direction by means of an articulation 33. The slot 3 arranged in the head part 1 now serves to hold the parking card 13 which is fixed there by the respective holding elements 7; 7a. This in turn has an additional advantage in that the parking card 13 cannot be misplaced inadvertently.

In summary, the essential advantages of the device according to the invention consist in that it may be used with parking cards 13 that have various material thicknesses, and that it has at least two different retaining forces:

A strengthened retaining force for the reliable withdrawal of the parking card 13 from the automatic machine 11, a low resistance force for introducing the parking card into the slot of the device and a low retaining force for reintroducing the parking card 13 into the automatic machine 11.

Moreover, the device is also designed such that it may be used to press the request key 10 on the automatic machine 11.

### REFERENCE LIST

1: Head part
2: Grip bar
3: Slot
4: Pusher element
5: Cover plate
6: Base part
7; 7a; 7b; 7c: Holding element
10: Request key
11: Automatic machine
12: Output slot
13: Parking card
24; 24a: Friction surface
25: Input slot
26; 26a; 26b: Clamping bar
30: Bracket
31: Ventilation register vanes
32: Clip
33: Knurled screw
34: Ventilation slot
35: Rubber cylinder
36: Guide slot
37: Guide element
39: Knob
40: Roller cam
41: Clamping insert
42: Stopper
43: Friction lining
44: Material attenuation
45: Eccentric axis

The invention claimed is:

1. A device for removing and reintroducing parking cards (13) from and into an automatic machine (11) provided therefor, comprising:
an elongated member (2) designed as an extension; and
a head part (1) that accommodates a parking card (13), a frontal face of the head part being constructed to operate as a pusher element (4) adapted to actuate a request button (10) on the automatic machine (11), the head part having an input slot (3) with clamping elements or holding elements (7; 7a; 7b),
wherein said clamping or holding elements are each constructed to exert different retaining forces on the parking card (13) automatically when picking up the parking card (13), removing the parking card (13) from an output slot (12) of the automatic machine (11), and when returning the parking card (13) to the input slot (25) of the automatic machine (11).

2. The device according to claim 1, wherein the holding elements (7; 7a; 7b; 7c) are embodied as a clamping bar (26; 26a; 26b) and are constructed and arranged to exert only a minimal pressure or clamping force on the parking card (13) when the parking card (13) is inserted in the input slot (3) of the head part (1) and when the card is removed from the input slot (3).

3. The device according to claim 1, wherein the holding elements (7; 7a; 7b; 7c) are embodied as leaf springs (7) and are constructed and arranged to exert only a minimal pressure or clamping force on the parking card (13) when the parking card (13) is inserted in the input slot (3) of the head part (1) and when the card is removed from the input slot (3).

4. The device according to claim 1, wherein the holding elements (7; 7a; 7b; 7c) are embodied as a clamping bar (26; 26a; 26b) and are constructed and arranged to engage the parking card (13) in the input slot (3) of the head part (1) with an increased retaining force when the parking card (13) is being removed from the output slot (12) of the automatic machine (11), and wherein an additionally flexible holding element (7b) impinges on the parking card (13).

5. The device according to claim 4, wherein the clamping bar (26; 26a; 26b) is mounted in the head part (1) so as to be swivellable freely about an eccentric axis (45).

6. The device according to claim 1, wherein the holding elements (7; 7a; 7b; 7c) are embodied as a clamping bar (26; 26a; 26b) and are constructed and arranged so that a retaining force is increased when the parking card (13) is reintroduced into the input slot (25) of the automatic machine (11).

7. The device according to claim 6, wherein the retaining force is increased by a half rotation about a longitudinal axis of the elongated member.

8. The device according to claim 6, wherein the retaining force of the clamping bar (26b) is increased by a resistance of the parking card (13) when the parking card is reintroduced into the automatic machine (11).

9. The device according to claim 6, wherein the retaining force is increased due to the holding element (7b) being embodied as a clamping bar (26b) and being pressed upwards upon contact with an insertion part of the automatic machine (11) the clamping bar being opened when contact with the parking card (13) is lost.

10. The device according to any one of claim 6, wherein the clamping bar (26b) accommodated in the head part (1) includes a stopper (42), which limits a swivel range of the clamping bar (26b).

11. The device according to claim 6, further comprising a friction lining (43) applied to the clamping bar (26b).

12. The device according to claim 2, further comprising a friction lining (43) applied to the clamping bar (26b).
